(19) United States
(12) Patent Application Publication
(10) Pub. No.: US 2026/0220504 A1
(43) Pub. Date: Jul. 30, 2026

(54) Joint Engagement Prediction, Distillation, and Inference with Label Context

(71) Applicant: Google LLC, Mountain View, CA (US)

(72) Inventors: Gil Shamir, Sewickley, PA (US); Matthew John Streeter, Los Altos Hills, CA (US)

(21) Appl. No.: 19/140,943

(22) PCT Filed: Dec. 19, 2022
(86) PCT No.: PCT/US2022/053303

§ 371 Date: Jun. 18, 2025

(51) Int. Cl. G06N 5/04

(52) U.S. Cl. CPC G06N 5/04

(57) ABSTRACT

Provided are systems and methods that enable computerized systems to optimize predictions of joint label probabilities of lists of items returned in response to a query. The proposed approaches take into account the effects of relational interactions among items included in the same list and can improve predictions of a deployed model for either predicting engagement rates, ranking, and/or distillation. Unlike methods that combine label engagement loss with a ranking loss, the proposed methods directly model the joint probability of the vector of labels in a list of examples included in a training dataset (e.g., by modeling conditional probabilities) instead of modeling the marginal and conditional projections of the joint probability and empirically balancing between them to infer some approximation of the joint probability. The approach gives models the ability to refine their label predictions based on the contexts of co-recommended items.

### FIELD

The present disclosure relates generally to machine learning. More particularly, the present disclosure relates to systems and methods for joint engagement prediction and inference where label context information is leveraged.

### BACKGROUND

Various settings exist in which a computerized system endeavors to provide a set (e.g., an ordered list) of items as responses to a particular query. Examples of such systems include recommendation systems, information retrieval systems (e.g., search engines), and/or other systems. A query can be implicit (e.g., defined based on context) or explicit (e.g., defined based on specific natural language and/or image input (e.g., input by a user)). A query can be user-agnostic or user-specific.

Many applications do not care about the actual labels associated with the recommended items, where the label for each item is indicative of a level and/or likelihood of user engagement with the item. Instead, such applications are only concerned with providing lists such that the items ranked higher in the list are more likely to receive (better) engagements from the users.

Other applications, however, endeavor to provide both accurate predictions of the engagement labels as well as accurate rankings among items recommended to a user. For example, in the search engine context, it is desirable to provide a list of search engine results in which the highest ranked items that are displayed most prominently (e.g., at the top of the search results page) are the most relevant items with which the user is most likely to interact.

In many such systems, models are trained to predict labels or item ranking without directly taking into account labels of other items included in the same list of recommendations.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method to train a machine learning model to perform joint engagement prediction, the method performed by a computing system comprising one or more computing devices, the method comprising: obtaining a training example comprising a plurality of items and a plurality of ground truth labels respectively associated with the plurality of items; and for one or more of the plurality of items: processing, with a marginal network portion of the machine learning model, feature data for the item to generate an intermediate representation for the item; processing, with the machine learning model, the intermediate representation for the item to generate a marginal label prediction for the item; processing, with a joint network portion of the machine learning model, the intermediate representation for the item and data descriptive of one or more previously or concurrently selected items of the plurality of items to generate a joint label prediction for the item; and modifying one or more parameters of the machine learning model based on one or more loss functions that evaluate the marginal label prediction for the item, the joint label prediction for the item, and the ground truth label for the item.

Another example aspect of the present disclosure is directed to a computer-implemented method to perform joint engagement prediction with a machine-learned model, the method performed by a computing system comprising one or more computing devices, the method comprising: for one or more of a plurality of items to be included in a list of items responsive to a query: processing, with a joint network portion of the machine-learned model, an intermediate representation generated for the item and data descriptive of one or more previously or concurrently selected items of the plurality of items to generate a joint label prediction for the item; and generating the list of items responsive to the query based at least in part on the joint label prediction generated for each of the one or more of the plurality of items.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIGS. 1-6 illustrate example implementations of example learning and/or inference techniques according to example embodiments of the present disclosure.

FIG. 7A depicts a block diagram of an example computing system according to example embodiments of the present disclosure.

FIG. 7B depicts a block diagram of an example computing device according to example embodiments of the present disclosure.

FIG. 7C depicts a block diagram of an example computing device according to example embodiments of the present disclosure.

Reference numerals that are repeated across plural figures are intended to identify the same features in various implementations.

### DETAILED DESCRIPTION

### Overview

Generally, the present disclosure is directed to systems and methods that enable computerized systems to optimize predictions of joint label probabilities of lists of items returned in response to a query. The proposed approaches take into account the effects of relational interactions among items included in the same list and can replace the use of combining a marginalized per item engagement (pointwise) loss together with a ranking loss that models the relations among items, for either learning better engagement labels or better ranking. Unlike such combined methods that use a ranking loss, the proposed methods can directly model the joint probability of the vector of labels in a list of examples included in a training dataset (e.g., by modeling conditional probabilities) instead of modeling marginal and conditional projections of the joint probability and empirically balancing between them to infer some approximation of the joint probability. The approach also gives models the ability to refine their label predictions based on the contexts of co-recommended items.

The proposed techniques can be used in training a model where both the joint label vector probabilities and the marginal label probabilities are learned. Learning the joint distribution in the same model adjusts the predictions of the marginal probabilities by those of the joint probability. Similarly to adjustments obtained by (non-deployable) ranking losses in combined approaches, these adjustments lead to better credit attribution internally in the model. The better internal credit attribution can improve inference accuracy of a model even if it can only predict the marginals at inference time due to system limitations.

If limitations of the deployed system allow, the proposed approach can also be used for inference in deployment to provide more accurate recommendations. For example, the proposed techniques can be applied at inference time if the deployed system allows phased decisions of which items to include in the list, where the set of items included in the list is selected first, and then predictions are refined and/or items are added one-by-one to form a ranked list of items (e.g., to be provided as search results, item recommendations, etc.). Applying the completely principled approach in such cases may incur high computational complexity. Instead, reduced complexity versions can be used. These versions can model relations relative to only the items ranked in the highest (e.g., “top-k”) positions, which in many applications accounts for the majority of relational interaction effects.

More particularly, in applications that require both accurate predictions of individual engagement rates and of ranking among the items, one could focus on designing a machine learning model that optimizes the individual engagement rates of all the items that are aware of interactions with other items. If these are predicted accurately, then both engagement prediction and ranking prediction should be accurate. This is, however, not quite the case with model misspecification. All real models are misspecified, as we do not know the “real” features that determine the user's behavior. Optimizing for accurate label predictions and for ranking may then lead to different model solutions. However, modeling the complete joint interaction among co-recommended objects can still improve the performance for the desired objective, whether it is accurate predictions or more accurate ranking.

In massive-scale systems it is hard or even infeasible to model full interactions among items that are shown to the user in one list in a response to a user query. This is because there could be an exponentially large combination set of items co-recommended together.

Therefore, one approach for returning a list of items is to train models that focus on individual engagement rates. The individual engagement rates are then used for both selecting recommendations to show to a user and for ranking them. This leads to individual predictions that are marginalized over all items that interact with the items recommended. Such marginalizations ignore effects of one individual item over another in a recommendation list. For example, if a system shows a certain item at the top of the list, this item can take away engagement from another item shown further down the list. The lower ranked item, when shown by itself, however, can still receive high engagements.

Such an interaction is not modeled by the individual engagement model and can lead to suboptimal performance of the system. Specifically, it can attribute the low engagement to the lower positioned item, where, in fact, the reason for its lower engagement is the presence of the high positioned item in the list. Furthermore, if the higher positioned item received engagement from the user, the presence of a positive label by itself takes away from the engagement of the lower ranked item. Similarly, items that are related to each other (e.g., contain the same information or content) may take engagements away from one another.

Including label context features, which describe the labels of items in the same list, in training can lead to better internal credit attribution in the model, even if such label context features cannot be included in inference of a deployed model. In the example above, if some content item shows with other content items that received engagements (e.g., clicks), and on those queries does not receive engagement due to the other engagements, but it receives higher levels of engagement if it shows without another content item that received engagement, a model can learn this with the context label feature. The prediction for that content item will then not be penalized for the lack of engagement due to the other engagements. Even if such a label context feature cannot be deployed, the deployable model can still marginalize better to not penalize (or favor) some content items in such a case. With better credit attribution, a model may also generalize better to counter usual distributions of examples (unlike ones it trained on), if it needs to perform inference on such examples.

Ranking losses such as pairwise ranking and listwise ranking can capture some of the interactions. Such (non-deployable) losses can be used in training to give a model the ability to form some credit attributions of the effects of one recommended item over another, yielding better ranking accuracy in lists of items recommended to a user.

Including such interactions in deployed models which serve the recommendations is challenging, however. If the list of items is selected from a huge list of candidates, where selection is done in parallel over the whole candidate set, modeling interactions may not be feasible in the selection phase, and, for lack of a better option, the marginalized individual predictions can be used.

However, if the system allows phased selections of items to recommend, the interactions can be modeled, and selection and/or ranking of the items can be applied by taking into account learned interactions. In some systems, this approach can be broken down into a selection phase that uses the marginalized predictions, and a refinement or ranking phase that takes advantage of the interactions between items.

When deployment, however, cannot support these interactions, capturing them in training may still be beneficial, as the model absorbs some of the information internally, allowing its predictions to better account for such interactions as well as to model misspecification, possibly yielding better prediction results in deployment, despite the inability to include the full information. Specifically, the model can capture labels in higher positions, and may be able to attribute lack of engagement with an item to positive or negative labels of items shown before it. For example, the model can capture that engagement with a higher positioned item may be the reason for a negative label of a similar lower positioned item, and not penalize the scores of the features of the lower positioned item.

Ranking losses such as RankNet and Softmax listwise that are used in applications that also need to accurately predict engagement rates are sometimes designed to leverage logit scores that are learned for the individual engagement rates also to the ranking task. A mathematical interpretation of these losses is that they seek to optimize conditional probabilities of an item having a better label than another conditioned on the event that the items have different labels. Thus, such losses have a flavor of focusing on conditional label probabilities of one item relative to the other while the “pointwise” individual engagement losses focus on the marginal label probabilities. This leads to an important observation. When both ranking and individual prediction tasks are important, the goal should be to model the joint label distributions of labels of items on a list. If the joint distribution is accurately predicted, then both marginal and conditional probabilities can be derived accurately, at least if models are correctly specified. Thus, for trying to achieve the best of both goals, a system should aim for best predicting the joint distribution. The ranking losses then are merely relational losses that optimize for conditional projections of the joint, whereas the individual engagement (pointwise) losses are projections of the joint that optimize the marginal.

One aspect that may still be advantageous using separate losses is that of model misspecification. Machine learning models use engineered features as the basis for the predictions they generate. Those are always misspecified relative to the features that actually dictated the user choices. Apart from marginalization, misspecification can lead to different optimal solutions for pointwise losses that use the marginal and ranking losses that use the conditional. There may be cases where ranking performs better for the conditional ranking loss than the joint, as the ranking optimization can eliminate some misspecified features, whereas optimizing for the joint may marginalize on the misspecification. For example, consider a linear model, where an important query feature that the model uses mixes multiple real populations. In reality, such a feature should be broken into multiple different features, but the model does not have that knowledge. Predictions of the joint distribution will learn one logit score for this feature which is marginalized over all populations. This can give a marginalized prediction to all items shown for every query that belongs to this union of populations. A ranking loss, such as a pairwise one, that uses the logit differences between two items, will drop the query feature altogether from the prediction, and can give a better specified prediction of the conditional probability described by the ranking loss. However, a well-designed model that predicts the joint probabilities can still capture the information in the logit differences by properly modeling the joint events for which the labels of both items are not equal.

In view of the above, example systems and methods of the present disclosure seek to provide a prediction of the joint probability among items selected for inclusion in a list responsive to a query, and specifically modeling (when possible) the effects of the context of other items' labels on the prediction of engagements with items. While this may not address all possible misspecification scenarios (such as the one described above), it will address the deviation between losses due to focusing on either the marginal or conditional, as well as many cases where misspecification leads the two objectives to different solutions. Focusing on the joint distribution is the appropriate modeling of a recommendation set, as it can attempt to model all interactions of the joint distribution a system processes in reality, instead of making assumptions that approximate projections of this distribution as the marginal pointwise loss and the conditional ranking loss. Instead of re-assembling the joint distribution from the marginal and conditional, the proposed techniques can model it directly.

The methodology proposed can be applied specifically to improve the joint individual label predictions. It can also, however, be derived directly for ranking losses, where such losses use label contexts of other items in training. For example, if the same list contains a pair of similar items to a pair under consideration, the label relation in the pair under consideration can be more likely to be similar to that of the context pair.

The proposed approach can be used by directly training machine learning models. It can also be used in a distillation setup. In such a setup, an expensive teacher can be trained with the label context (of other co-recommended examples). Then, the predictions of the teacher are used to train a simple, deployable, student model that can train preferably with but possibly also without that label context.

As mentioned above, some systems may not be able to benefit from relations between items in deployment. Thus, example implementations of the present disclosure demonstrate how this approach can be used in training only, so that attribution of the joint label vector distribution propagates to the model weights in a similar manner to the effects of a ranking loss. This approach can also allow a deployed model that serves marginal predictions to, at least, leverage context and label credit attribution such that the marginal predictions better account for the interactions between items and the effects of items' labels on other items. The proposed approaches are applicable whether applied to problems with only binary labels, or with graded relevance multi-class labels.

Training with a loss that is aware of the joint interactions and the labels of items that are shown in positions before an item can set up the model for better credit attributions. It will allow, for example, attributing negative engagement to positive engagements of other items higher on the list instead of penalizing items for it. In particular, similarly to training with ranking losses, the problem can be viewed as a multi-task training problem, where one task learns the marginals, which are necessary in deployment, and the other the joint distributions leading to possible improvements on both individual prediction and ranking tasks in deployment by accounting for the joint probability relations. In addition, modeling the joint probabilities will improve training and evaluation of logarithmic losses in systems which train to optimize cross entropy loss.

Another aspect of the present disclosure provides approaches which are modified to apply to the case where deployment first uses the marginal to select items, but then orders (scores, or ranks) the items accounting for the interactions between them. Training, as in the training only setup, can leverage the true labels of items preceding an item (and can attribute low engagement with a lower ranked item to positive labels of items ranked above it). Training can also further take advantage of noncausal, double sided, label context. Deployment, of course, is unable to leverage these labels. Training therefore prepares for the deployment ranking phase, which can still leverage the contexts of items preceding an item, but not the label.

The method proposed for training with deployment also accounts for phased inference in deployment. The first phase for selecting the items allows costly inference through a deep network. A second phase of incrementally ranking the items should then be performed with low latency. To allow for this low latency at the ordering stage, the model can first use a high capacity accurate deep network to select the list of items to recommend using marginal predictions, and then use the (context-vector) information in the penultimate layers of the marginal scoring model to further refine predictions to account for interactions while gradually selecting the order of the items to recommend.

### Example Implementations for Predicting Joint Probabilities in Training (Only)

There has been abundant work on designing models that use context information for the prediction of individual labels or item relational labels. Context information in this line of work applies to features describing items included (e.g., co-recommended) in the same list as the item whose engagement the model predicts. Such features may include the probability predicted by the model for positive engagement of these items. Such context, however, is only a part of the picture. The realization that modeling should directly optimize the joint distribution sheds light on the fact that in addition to the feature context of co-recommended items, the context should include the actual labels of the co-recommended items. By first principles, training should minimize the loss of prediction of the joint probability of the recommended list, conditioned on the features of all items in the list. Such a joint probability can be expressed by a product of conditionals, conditioned on the features and labels of items in higher positions.

Consider a list of N items. Items can be any item potentially included in a list, such as items of content (e.g., webpages, images), movies, items of clothing or home goods, people, users, entities, locations, businesses, files, electronic mails, messages, advertisements, and/or any other items. Let item i∈{1, 2, . . . , N} be defined by the pair {xᵢ, yᵢ}, where xᵢ is a feature vector defining the features of item i, and yᵢ∈{0, 1, . . . , L−1} is the label in an L-ary size label alphabet. In many cases, yᵢ∈{0,1}, but the proposed techniques are not restricted to the binary label case. In fact, the approach described should also allow for continuous labels, if probability densities are considered instead of probability masses. For simplicity, the method is presented with probability masses, but one could use the methods with densities as well. For the optimization, we thus model the joint probability of the label vector conditioned on the feature vector. Capital letters are used for random variables and lower case letters are used for their values. For notation compactness, we use

$${z}_{i}^{j} = ( {z}_{i} , {z}_{i} + 1 , … , {z}_{j} )$$

to denote a subsequence from i to j. The model trains on lists of items co-recommended together, and for each list predicts the joint label sequence probability

$$Pr \{ ( {Y}_{1} , {Y}_{2} , … , {Y}_{N} ) = ( {y}_{1} , {y}_{2} , … , {y}_{N} ) \vert ( {x}_{1} , {x}_{2} , … , {x}_{N} ) \} = {\prod }_{i = 1}^{N} Pr \{ {Y}_{i} = {y}_{i} \vert ( {Y}_{i} , … , {Y}_{i - 1} ) = ( {y}_{i} , … , {y}_{i - 1} ) , ( {x}_{1} , {x}_{2} , … , {x}_{N} ) \} {=}^{Δ} {\prod }_{i = 1}^{N} Pr \{ {Y}_{i} = {y}_{i} \vert {Y}_{1}^{i - 1} = {y}_{1}^{i - 1} , {x}_{1}^{N} \} \qquad ( 1 )$$

where for

$$i = 1 , {y}_{1}^{i - 1} = ϕ$$

is an empty set.

In training, the probability in equation (1) can be computed by conditioning the label probabilities of all items i on all contexts xⱼ, for j=i and both j<i and j>i. However, in deployment, it is often not the case that a system selects items to include in the list depending on items that will be selected subsequently. Furthermore, in many practical cases, the effects of items higher on the list on those that follow are usually larger than the effects of items lower on the list on those that precede them (although this is clearly not the case for the first item in the best position in the list). Therefore, a first optional approximation of equation (1) can be made by using only the causal context:

$$Pr \{ {Y}_{1}^{N} = {y}_{1}^{N} \vert {x}_{1}^{N} \} \approx {\prod }_{i = 1}^{N} Pr \{ {Y}_{i} = {y}_{i} \vert {Y}_{1}^{i - 1} = {y}_{1}^{i - 1} , {x}_{1}^{i} \} \qquad ( 2 )$$

In systems that first select which items to include in a list, and then order them, it may be possible to use noncausal context, but with missing position information on some of the items.

In many recommendation systems, the items shown in the first k positions are the ones with the most significant effects on items shown in lower positions. The effects of items shown in positions i>k on subsequent positions, while they exist, may be rather small. Thus, another optional approximation can be made in which we can model the conditional probability only conditioned on the labels and contexts of the items shown in the top k positions. This approximation, again, is not as vital for training, but it can substantially reduce complexity in deployment. Thus, equation (2) can reduce to

$$Pr \{ {Y}_{1}^{N} = {y}_{1}^{N} \vert {x}_{1}^{N} \} \approx {\prod }_{i = 1}^{N} Pr \{ {Y}_{i} = {y}_{i} \vert {Y}_{1}^{min ( i - 1 , k )} = {y}_{1}^{min ( i - 1 , k )} , {x}_{1}^{min ( i - 1 , k )} , {x}_{i} \} \qquad ( 3 )$$

Typical recommendation systems train deep network models. Given that the model must produce marginal predictions of individual engagement rates, as well as be able to better predict the joint label probabilities, it may not be feasible to use a single deep network to produce either the joint predictions to the observed label vector or the product of conditional predictions. Current systems use factorized networks to produce the marginal label probabilities. More precisely, the same neural network is used for predicting labels of all items, except for the input features. Those can be entered as learned embedding inputs to the network, which updates them together with the internal network link weights and biases. Due to the large scale, the features producing the embeddings are sparse features, and often the vectors xᵢ are combinations of embeddings that were never observed before as the same combination.

The factorized approach can be used as a third optional approximation that can be applied to any of the forms in equations (1), (2) or (3). Instead of using a single network, output layers of the factorized networks used to produce the marginal predictions for each of the items can be used as context input vectors or summary embeddings (e.g., in addition to the label) into an additional aggregation network. The aggregation network produces the conditional label probability of item i conditioned on its own context, and that of either all other items (equation (1)) or a subset of items (equations (2) and (3)) as well as on the labels of all preceding items.

In addition to the formulations of equations (1), (2), and (3), an a-posteriori approach can also be considered in training, where predictions of each item are obtained conditioned on the double sided context, including that of the labels. In situations where modeling the context information is complex, there can still be benefit from using only the label context either causal or double sided in training. This can still improve internal model credit attribution to provide better predictions in inference, filtering out effects that are solely due to label values of other items.

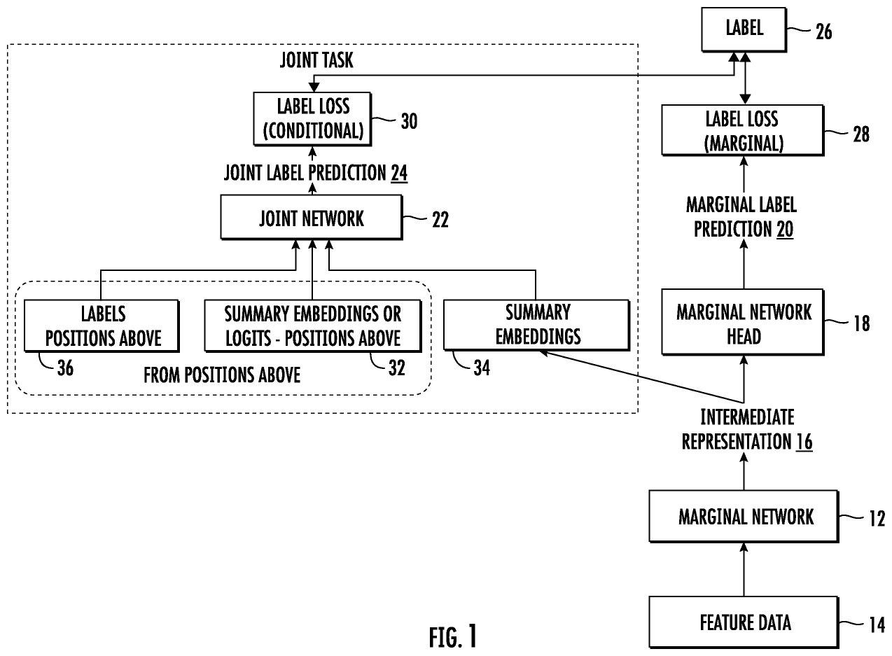

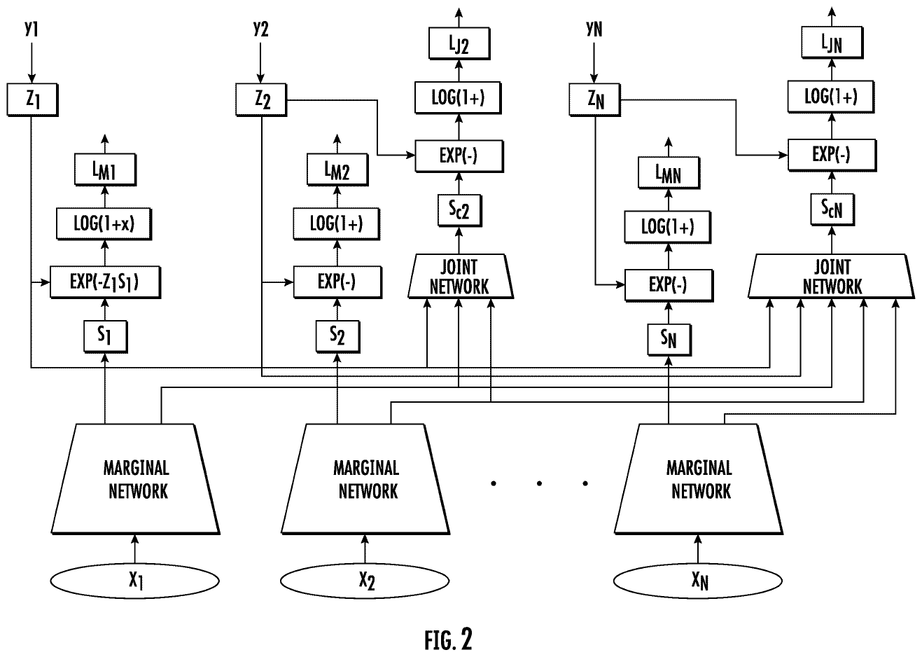

FIGS. 1 and 2 illustrate example implementations of the learning method. In particular, FIG. 1 shows a simplified block diagram of a single item in some position using both summary embedding contexts and label contexts of items in positions above the item. The three approximations (causal context only, context of only top k positions, and factorization across items using their contexts) can be built into the example process shown in FIG. 1. The model can be thought of as a (two tasks) multi-task learning method, learning both the marginal label predictions of an item marginalized on labels and contexts of other items, and a joint label distribution prediction, learning the conditional label probabilities of an item conditioned on labels and contexts of items in positions above.

Specifically, in some implementations, a training example can include a plurality of items and a plurality of ground truth labels respectively associated with the plurality of items. The ground truth label for each item can provide a ground truth indication of a level of engagement from a user when presented with the item (e.g., when presented with the plurality of items). The labels can be binary labels or multi-label labels. FIG. 1 provides the general perspective of application of a machine learning approach to a single item in the plurality of items.

In particular, with specific reference now to FIG. 1, a marginal network portion 12 of the illustrated machine learning model can process feature data 14 for the item to generate an intermediate representation 16 for the item. The feature data 14 can be raw feature data or can be feature embeddings generated by this model as part of its training, by a different model or otherwise previously generated in some fashion. The input to the marginal network 12 can also include information about a query for which the items are candidate responses.

The marginal network 12 can, for example, be a feed-forward neural network or other form of neural network. However, the marginal network 12 can also be some other form of machine learning model (e.g., including both linear and non-linear models).

In some implementations, the intermediate representation 16 can be an embedding (e.g., a numerical vector) or other data retrieved from or output by a layer (e.g., a hidden layer) of the marginal network 12. In some implementations, the intermediate representation 16 can be a logit score, as will be described in further detail below.

Referring still to FIG. 1, a marginal network head portion 18 of the machine learning model can process the intermediate representation 16 for the item to generate a marginal label prediction 20 for the item. As one example, the marginal network head 18 can be a softmax function or other output function or layer(s) to generate the marginal label prediction 20 from the intermediate representation 16.

In addition, according to an aspect of the present disclosure, a joint network portion 22 of the machine learning model can process the intermediate representation 16 for the item and data descriptive of one or more previously or concurrently selected items of the plurality of items to generate a joint label prediction 24 for the item. The joint label prediction 24 can be a prediction of the conditional probability distribution of the labels for the item, conditioned on the contexts and/or labels of items in positions above this item. The joint network 22 can, for example, be a feed-forward neural network or other form of neural network. However, the joint network 22 can also be some other form of machine learning model (e.g., including both linear and non-linear models).

As one example, the data descriptive of one or more previously or concurrently selected items of the plurality of items can include summary embeddings 32 associated with the one or more previously or concurrently selected items of the plurality of items. In some implementations, the summary embeddings 32 are logit scores associated with the one or more previously or concurrently selected items. In some implementations, the summary embeddings 32 is a single summary score associated with the one or more previously or concurrently selected items of the plurality of items (e.g., an average of previous embeddings). The summary embeddings 32 can also be an intermediate representation 16 of items other than the item of summary embeddings 34. As shown at 34, the intermediate representation 16 for the current items can be added to the summary embeddings for the next sequential item.

In some implementations, the data descriptive of one or more previously or concurrently selected items can include the ground truth labels 36 for the one or more previously or concurrently selected items of the plurality of items. The labels 36 can be in addition to or as an alternative to the summary embeddings 32.

In some implementations, the one or more previously or concurrently selected items can include all previously selected items. In other implementations, the one or more previously or concurrently selected items comprises only a top-k number of previously selected items.

One or more parameters of the machine learning model can be modified based on one or more loss functions that evaluate the marginal label prediction 20 for the item, the joint label prediction 24 for the item, and the ground truth label 26 for the item.

As one example, a joint loss function 30 can evaluate the joint label prediction 24 and the ground truth label 26 to generate a loss value. As one example, the joint loss function 30 can be a cross-entropy loss applied relative to the true label 26.

The joint loss function 30 can be used (e.g., by or via backpropagation) to modify parameters of the joint network 22 and/or the marginal network 12 of the machine learning model. Thus, in some implementations, the joint loss function 30 can be backpropagated through a processing path that includes the intermediate representation 16 for the item so as to update the instantiation of the marginal network 12 illustrated in FIG. 1.

As another example, in some implementations, the data descriptive of the one or more previously or concurrently selected items (e.g., the summary embeddings 32) can include or be derived from outputs of one or more prior instantiations of the marginal network of the machine learning model. For example, the summary embeddings 32 may have previously been generated by prior instantiations of the marginal network when given feature data descriptive of the previously selected items. Thus, in some implementations, modifying the one or more parameters of the marginal network portion of the machine learning model can include backpropagating the joint loss function 30 through a processing path that includes the summary embeddings 32 and the one or more prior instantiations of the marginal network so as to update parameters of the marginal network.

As another example, a marginal loss function 28 can evaluate the marginal label prediction 20 and the ground truth label 26 to generate a loss value. As one example, the marginal loss function 28 can be a cross-entropy loss applied relative to the true label 26.

The marginal loss function 28 can be used (e.g., by or via backpropagation) to modify parameters of the marginal network head 18 and/or the marginal network 12 of the machine learning model. As one example, the marginal loss function 28 can be back propagated through the intermediate representation 16 for the item to modify parameters of the instantiation of marginal network 12 illustrated in FIG. 1.

Thus, FIG. 1 depicts an example configuration for training with a marginal network 12 and a joint network 22 for a single item in a list using labels and/or contexts of items that appear in positions above the item in a list of items. The model can learn input feature embeddings and hidden layer parameters connected to the marginal network 12 that trains against the true label 26, as well as connected to a second task joint network 22 that learns also against the true label 26, but includes inputs of summary embeddings 32 and/or labels 36 of items in positions above the item. Hidden layer parameters can be shareable across different items in the list.

In particular, the marginal network 12 (e.g., including the head 18) generates marginal label predictions 20 that can be used for initial selection of recommendation items. The joint network 22 can affect credit attribution of the hidden layers and feature embeddings of the marginal network 12, so that marginal predictions 20 better account for context and label interactions, and give better projections of the joint label distribution.

If applied only in training, the role of the joint network 22 is similar to that of a ranking loss. By itself, it does not have to be deployed, but through the connections to the hidden units and embeddings of the marginal network 12, it affects the marginal predictions 20. The label information 36 can help the model attribute a negative label to a context of a positive label in a position above, thus not propagating negative gradients to the hidden layers and embeddings of the marginal network 12. Such attributions are opposite to those imposed by ranking losses. Pairwise ranking losses may eliminate the effect of features that contribute equally to two items, possibly pushing against pointwise losses. However, if such features are responsible for a positive rate of at least one item, the joint loss will not suppress them, and will capture the joint interaction.

In many applications, a separate loss on the marginal network may not be at all necessary. This, however, may not be possible in cases in which deployment is not aware of the context, but requires per-position predictions, in cases, where all positions, including the first one are trained with non-causal contexts, or in cases where some items only show in some positions and the model cannot generate more generalized predictions for these items. If context is available only in training, and deployment uses only a single top score per each item, however, it can be sufficient to train only with the context dependent label loss 30 (and without the marginal label loss 28) and infer the prediction for the first position, for which, in the causal setting there is no context influence. If this is done, measuring training accuracy of predictions without the context of positioned items that are not in the top position is not possible as no such prediction will be available.

In FIG. 1, pointwise label loss such as cross entropy is used in training to provide accurate per item label predictions. If ranking items is an important task, a similar approach can be used as in FIG. 1 on pairs of items with a pairwise ranking loss either instead or in addition to the loss used in FIG. 1. Context free marginal predictions are first produced for the pair. Then, these are refined leveraging the context and labels of other items in the list. Because ranking pairwise predictions are not deployed in such systems that infer individual label predictions, it is not necessary to include a marginal ranking prediction loss 28 altogether, and ranking loss can be fully trained with the context of other items (causal or double sided) with the joint task loss 30.

The approach described for either label pointwise and/or ranking loss as shown in FIG. 1, but without a marginal loss, can be used to train a more complex teacher model, whose predictions are distilled to a simpler deployable student model. The student model can be trained with or without the contexts on the teacher's predictions.

The learned parameters of the hidden layers of both networks 12 and 22 can be shared among all items in the list, but different sparse embeddings (e.g., intermediate representation 16) can be learned for each item. Predictions 24 of the joint network 22 can also be marginalized over the label 26 to give better predictions for ranking items in deployment. However, this requires multiple inferences to marginalize over all possible labels of each context item.

FIG. 2 shows a more detailed list-level view of applying training on a list of items. To simplify notation, we map the label yᵢ∈{0,1} to zᵢ∈{−1,1}, where zᵢ=2yᵢ−1 for the binary case. To keep the inputs of the joint network in the same scale, the actual inputs to the network representing the labels can be scaled versions of zᵢ, for example in {−r, r} for some r>0. This is consistent with normal limited range of the summary embeddings (on which nonlinearities like ReLU are not applied). For the graded relevance or multi-labels case, mappings from yᵢ to zᵢ can be defined in different ways. The marginal network can learn logits sᵢ with loss L_{M} (marginal loss), and the joint network can learn conditional logits s_{ci} with loss L₁ (joint loss). In the binary labels case, the training losses for the item list can be the following example losses:

$${L}_{M} = {\sum }_{i = 1}^{N} log \{ 1 + exp ( - {z}_{i} \cdot {s}_{i} ) \} \qquad ( 4 )$$

$${L}_{J} = {\sum }_{i = 1}^{N} log \{ 1 + exp ( - {z}_{i} \cdot {s}_{ci} ) \}$$

For multi-labels, logits can be considered vectors of logit scores, and the loss equations can be modified accordingly, e.g., using negative logarithms of Softmax probabilities. Training loss can be balanced between the two losses as:

$$L = α {L}_{M} + ( 1 - α ) {L}_{J} \qquad ( 5 )$$

where α can be considered as a regularization scale.

In some implementations, one goal can be to learn the joint probabilities, so that L₁ is the objective the system wants to optimize towards. However, because in some implementations, the joint prediction is not used at least in the item selection phase, a calibrated prediction for the marginal label is useful. Thus, L_{M} can be used to achieve this calibration, and can be viewed as a regularizer. With this consideration, a should be kept relatively small. However, it can be tuned to properly maximize metrics of interest, where model misspecification relative to the dataset can affect the tuning. The inputs to the initial bottom marginal networks are the feature data or vectors xᵢ (or embedding vectors representing them). The total loss of the training dataset aggregates the losses of equation (4)-(5) over all item lists in the dataset.

Thus, FIG. 2 shows an example training setup for learning logits (sᵢ) for marginal item probabilities and logits (s_{ci}) for conditional item probabilities conditioned on items that precede i on the list for training on a list of N items. The bottom marginal networks take feature embedding vectors xᵢ as inputs. The marginal network for item i produces its marginal logit score or scores sᵢ (with the left output path of each marginal network). The scores are connected to all units of the penultimate layer of the network. Backpropagation with loss (e.g., logistic loss) against the true label update the scores sᵢ, the marginal networks and their inputs. Each of the marginal networks outputs the top layer (e.g., summary embeddings, shown as the right output path of each marginal network) which serve as part of the input of the upper joint networks. An upper joint network for item i takes inputs including the summary embeddings of item i, the summary embedding of items j<i (as context), and the labels of items j<i. The i′th joint network (i>1) outputs conditional logit scores or vectors s_{ci} which are updated with loss (e.g., logistic loss) against the true label of item i. Backpropagation from this loss updates the top joint network, but can also propagate to some or all the instantiations of the marginal network which are connected to the top network through its inputs. This full propagation embeds the joint distribution information in the multiple instantiations of the marginal networks.

In a causal implementation, the item in the top position in a list has no context. Therefore, s_{c1}=s₁. In FIG. 2, the marginal network branch producing loss L_{M1} can be applied once for L_{M} and once for Lⱼ using the defined weights α and 1−α, respectively. The conditional scores of all items in positions i>1 are produced by the joint networks. As shown also in FIG. 1, these networks can optionally take three inputs: 1. Each item's own (summary embeddings) context, 2. the summary embeddings contexts of items in positions above this item, and 3. The labels of items in positions above this item.

With equation (1), the joint networks take “noncausal” contexts of all other items in the list. A noncausal context is valid in training when the joint predictions are not used in deployment. With equation (2), they take causal contexts of all items j<i in positions above an item's position. Using equation (3), contexts of only at most top-k items j<i such that j≤k in positions above an item are taken. As mentioned, learned hidden layer parameters can be shared among all items also for the joint networks. Items in higher ranked positions i can fill inputs for contexts in positions j≥i they precede with neutral (e.g., zero valued) inputs with such sharing, where there exists some upper bound (k in equation (3)) on the number of context items. With equation (3), the network will have k label inputs and k+1 summary embeddings context inputs (e.g., the +1 corresponding to the item's own context). For N>>k, this illustrates the savings in equation (3), which is substantial if deployed. Labels zⱼ of all j<i for equations (1) and (2), and of all j<i and j≤k for equation (3) are used. FIG. 2 illustrates equation (3) with k=2.

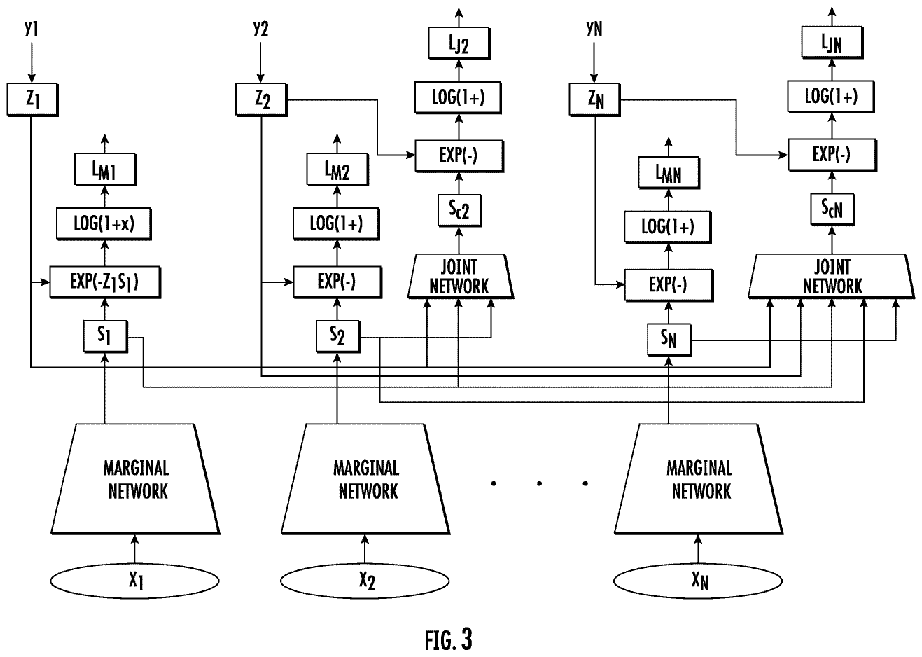

According to another aspect of the present disclosure, instead of using full context summary embeddings as inputs of the joint network, the logit scores of the context items can be used as shown in FIG. 3. This still allows propagation of gradients to the marginal networks to update joint probabilities. However, it does mask cross context (similarity) information from the joint networks. Thus it can reduce complexity, but possibly at some cost. Another alternative, is to use one summarized (e.g., averaged, summed, or processed differently) context score (or vector) from all contexts of items in positions above (or other positions) as the context input to the joint network of an item. This approach is similar in some respects to one of self-attention along the vector of per item context-vectors. Similarity scores (such as cosine similarity) can be used instead or in addition to summary embedding contexts. Another simplification can use only the item's context and the label information of items in above positions, excluding contexts of above position inputs from the joint network. This may reduce complexity but also propagation of cross context information, possibly obtaining suboptimal performance.

The training (only) configurations described in this section and shown in FIGS. 1-3 allow full backpropagation of gradient updates from the top joint networks to the bottom marginal networks for both the processed item and its context items (in positions ranked above it). This allows attributions of the joint label distribution to propagate to all parameters of the model, including those of hidden layers of the marginal network and the input features. This can refine the marginal predictions. Such refinements allow better credit attribution among model parameters for each of the items, also better resolving misspecifications. Better attributions allows for better marginal predictions and is beneficial because in some implementations the marginal predictions are the only ones that are inferred in deployment. The method proposed here is thus different from a calibration method that uses the context network to calibrate the prediction of the marginal network so that the prediction of the context network can be deployed for ranking subsequently to the marginal predictions used for item selection. A calibration method produces residue prediction to be joined with the original (marginal) score for a full context aware prediction. StopGradients can be applied in calibration between the context network and the marginal one. Here, however, such StopGradients will block propagation of the information that the method is designed to propagate. It is possible to stop gradients to the context summaries of items in above positions, but this can reduce the effectiveness of modeling joint interactions.

Information about the item's position in the list, its user interface (UI) and its rendering format also affects marginal and joint engagement rates. Training should already include this information in the marginal network and contain techniques to attribute credit between positional features and item quality ones. In the training only setting, the information from the marginal network is used for both item selection and subsequent item ranking. Thus the marginal network should be able to attribute credit between the item's marginal engagement rate and the effect of position and other UI features. In systems that allow phased ranking where items are incrementally selected, joint networks can utilize the position information better during per-position item selection, as described in the next section. For the training only setting, the marginal network already includes the positional information, either as part of the input features or in more advanced ways, and the joint probability effects propagate also to the parameters representing these positional/UI effects.

### Example Joint Probability Training and Context Deployment

The example techniques described in the previous section are geared towards using the joint network that produces the joint label distribution as a second training task, which is not deployed, but during training refines the marginal predictions similarly to a ranking loss. In other implementations, the predictions of joint network outputs can be deployed. In order to use them in inference for some position i, example systems can infer Lⁱ⁻¹ times for position i, where L is the label alphabet size (e.g., number of classes), to compute both the probabilities of each of the label contexts, and then the conditional probability of item i taking some label value b for each label context. The prediction for item i taking label value b is then marginalized over all the resulting joint probabilities. This approach can be implemented more efficiently by computing the context probabilities incrementally storing the full label context tree while making per position selection. However, even then, this creates deployment complexity to levels that may be infeasible.

Instead, provided are example techniques geared towards leveraging the joint probabilities in training as well as the context in deployment. Some example implementations train using three losses: 1. For predictions marginalized on both the contexts and labels of items in above positions, 2. For predictions marginalized over the labels of items in above positions, but aware of their contexts, and 3. For conditional predictions conditioned on both contexts and labels of items in positions above the item. If context-free inferences are attained by the context prediction of the first position, the first loss can be absorbed in the second.

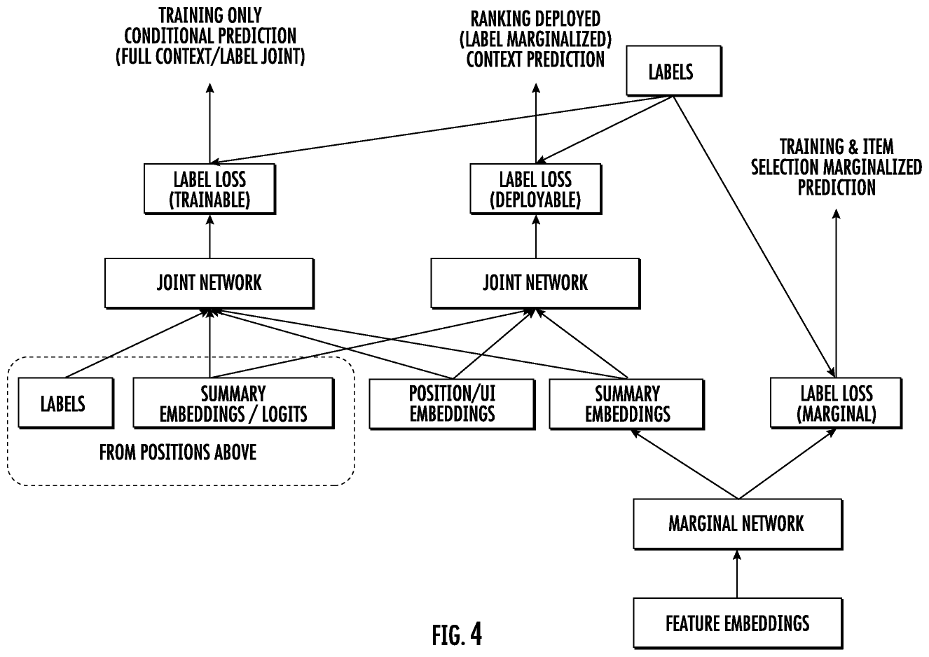

The first marginal loss can be used in deployment for initial selection of items. The second context conditional loss can be used in deployment for sequentially ranking items conditioned on the contexts of already selected items. The third loss can be used in training (e.g., only during training) to ensure proper attributions to the first two losses. This approach is illustrated in FIG. 4. The first loss is similar to the one in FIGS. 1-3, using an expensive network from the inputs to the label loss output. In deployment, forward propagation can be limited to only once on this network for each item. These networks produce summary embeddings or context-vectors (e.g., as in FIG. 2) or summary logits (e.g., as in FIG. 3) for each of the items. The summary embeddings/logits can be used together with those of the items in positions above as inputs to the two other networks.

Both networks can also combine positional feature inputs with the context embedding inputs. The positional features are not necessary in the first marginal network, because inference of this network is only used to determine the selected items, but not their rankings. Position features can still be included in the marginal network, but then inference must either marginalize over them or use the score of the top position for selecting the items

With reference to FIG. 4, the joint network shown in the middle can use the three categories of inputs (e.g., context of the item inferred, contexts of items in positions above it, and position information) to produce a position and context-aware (but not label-aware) prediction against the true label. This context-aware prediction can be deployed in a sequential per position ranking phase, and is marginalized over the context labels. The joint network shown on the left-hand side can receive the labels of items in positions above the item as inputs in addition to the previous three categories. It produces the conditional probabilities predictions conditioned on the contexts and labels of items ranked above the item for causal training, but can also receive contexts and labels of all other items on the list for non-causal training. It is not deployable but does allow gradients to flow from it to the marginal network and the joint network inputs. This flow of gradients refines the deployable predictions of the other networks. Keeping the joint networks simple allows multiple inferences to be performed using the contexts produced by the single per item inference on the expensive marginal network.

Thus, FIG. 4 depicts an example context- and label-aware training of an item in a list of items. A marginal network (on the right) containing features of the item is trained with label loss against the true label. It generates summary embeddings (or logits), that together with positional features and context summary embeddings (or logits) of items ranked above this item are used in a second joint network (shown in the middle) to produce a deployable context-aware prediction against the true label. An additional joint network (shown on the left) uses the same inputs with the addition of the labels of the items in positions above the item to train a context- and label-aware prediction. Gradients from the label-aware joint network can backpropagate into the features and parameters of the item to refine both deployable predictions (the marginal one and the context-aware (but not label-aware) one).

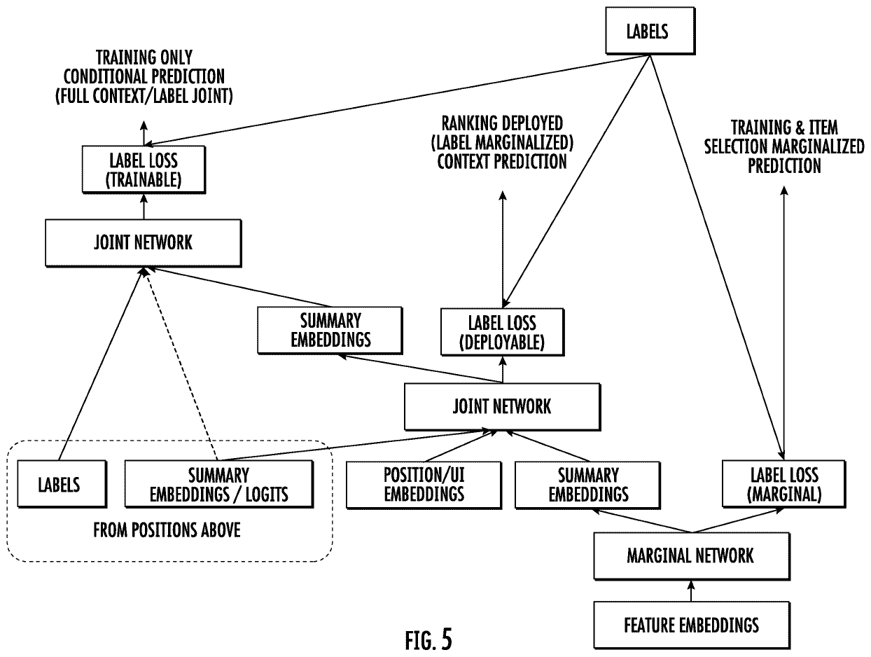

FIG. 4 provides one possible configuration. Other configurations for this approach are also possible. FIG. 5 is another example. FIG. 5 cascades the label-aware joint network on top of the context-only joint network, where summary embeddings summarizing the context-only joint network are used as inputs to the label-aware joint network, replacing the need to include the positional and the items summary embeddings. The summary embeddings of the context items can be included as inputs too, but can alternatively be (only) included in the context summary embeddings of the context network instead.

Thus, FIG. 5 depicts a deployable context- and label-aware training of an item in a list of items. FIG. 5 is similar to FIG. 4, but with a different configuration, in which a summary embeddings layer of the context-only joint network is used as input to the label-aware joint network, replacing the summary embeddings of the marginal networks and the position features. Context summary embeddings of other items produced by their marginal networks can also optionally be included as input of the label-aware joint network, or can alternatively be described only by the summary embeddings produced of the context-only joint network.

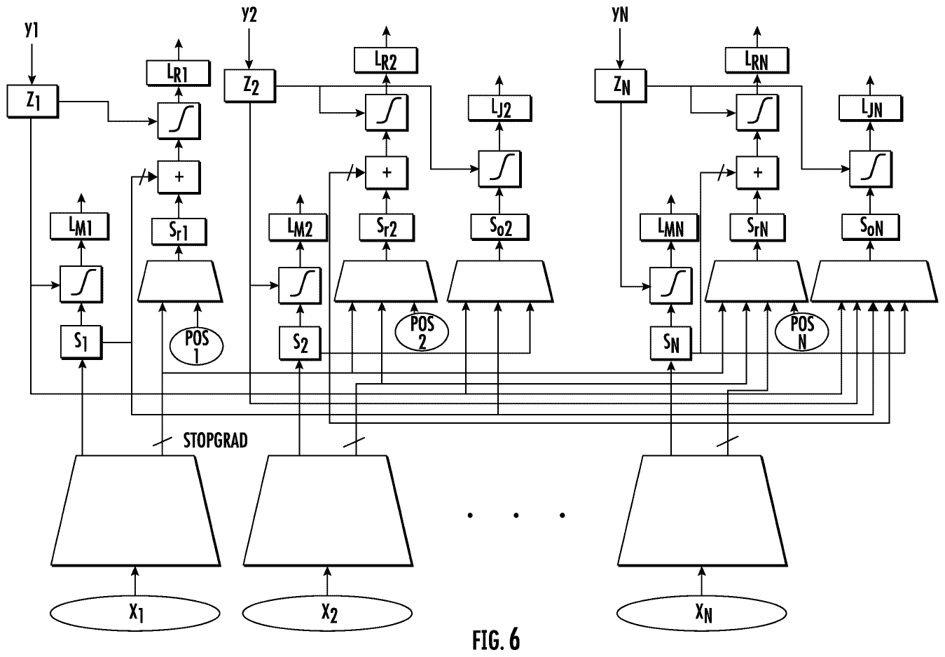

The approach in FIGS. 4-5 is not a calibration approach and does not require stopping gradients between networks. Gradients from the context- and label-aware joint network should flow to the other networks to refine their predictions. However, StopGradients can be applied on the context-only joint network in FIG. 4 (but not the one in FIG. 5) over the context and position inputs to this network. This allows training to be applied similarly to the training only methods in FIGS. 1-3, between the joint network and the marginal one, where the context-only joint network is isolated, and computes its own marginalization for its context-aware predictions. Alternatively, the context-only joint network can be applied as a calibration network as demonstrated in FIG. 6, where it takes context inputs of the processed item and its context with StopGradient. The contexts, along with position features, are used to forward propagate context-aware deployable refinements to the marginal predictions. However, gradients from the context-only joint network do not flow to the contexts, but do update the position features. The label-aware joint network in FIG. 6 refines the positionless marginal predictions, but marginalizes on the position, giving full control of the position to the context-only joint network. Ranking per-position inference uses this information, but training marginalizes the position. Alternatively, the position can also be included in the label-aware joint network.

### Example Training for Marginalized Context Aware Deployment

In addition to using multiple inferences or the approaches in FIGS. 4-6 for deployable context-aware models, example implementations can also use the techniques illustrated in FIGS. 1-3 with random dropout for label-context marginalized deployable context-aware predictions. This can be done by training the configurations in FIGS. 1-3, but for a fraction of the training item lists, dropping the label (only) information from the inputs of the joint network and replacing it by a neutral (e.g., zero valued logit) label input. In deployment, example implementations can use the same input for the context labels on all context items. This should allow using the joint network to produce a context label marginalized, yet context-aware prediction for each item.

### Example Deployment

The approaches described above can be used in training, where deployment either uses the marginal network, or if no marginal network loss is trained, the context-free prediction of the first position (in the causal training case).

Deployment of the proposed methods (when implemented) can be applied in systems that employ phased approaches, first selecting items with either the marginal network or the top position context-free predictions if no marginal network loss is trained, and then sequentially ranking the selected items per position using the joint network or just the context-only joint network. First, expensive inferences on the more expensive marginal networks can be applied to select the items with the best predicted marginal engagement labels. In practice, selection can be done in parallel. Thus, using the conditional probabilities sequentially is often infeasible. One can imagine selecting the top position item first from the full candidate set, then using the joint predictions to sequentially select items for subsequent positions. However, this will require multiple inferences to the full candidate set. In addition to generating marginal label predictions, summary context embeddings (or logits) can be generated for all items in this stage. These can be used at the ranking stage without the expensive cost of forward propagating again through the expensive marginal network. The joint network is designed to be cheaper and faster to forward propagate through to generate predictions. In the marginal selection phase it is possible to initially select longer lists than the number of items to be included in the recommendation lists.

The first selection phase is followed by a second per-position ranking phase, where the joint networks are now used sequentially to generate context- and position-aware predictions for each of the items not previously selected. In some implementations, these can be generated by forward propagating on the context-only joint networks shown in FIGS. 4-6, with the position information and the context inputs summarized from the marginal networks. If systems use the dropout approach, the methods in FIGS. 1-3 can also be used by forward propagating on the joint networks with neutral label inputs, to generate context-aware predictions. Alternatively, this can also be done by inferring multiple times to compute context- and label-aware predictions and marginalize them over all possible label contexts. However, this approach may be computationally challenging, especially in multi-label applications, where all label contexts must be included in the marginalization.

### Example Look Ahead Ranking

Selecting the item with the best predicted utility to the first available position may not always be the optimal approach. (Utility implies the best score for which the predicted probability is just a component. For example, in CTR, the score consists of the product between the predicted CTR and the bid.) It is possible that the item with the largest engagement could substantially reduce the expected engagements of subsequently shown items, such that in the average the expected engagement will decline. The phased selection can be used with tree search or dynamic programming to select ranking to maximize the per-query utility. One form will define states as the set of items already selected, or the top k items to keep complexity low. A simple approach can select the next item using a total return metric consisting of the predicted utility of all candidate items conditioned on the current context of previously selected items. Each can be superimposed with the expected return of the best next m items selected subsequently to the current candidate if selected with the context of previously selected items and the current candidate. More precisely, compute a return metric for item A selected in position i, conditioned on the context of all items in positions 1 through i−1, but also sum the predicted return of the next top m items conditioned on the context in positions 1 through i, where A is the item in position i.

A simpler approach could just look at the expectation of the predicted utility for any item following A combined with that of A. Instead of selecting A based on its own predicted utility given the context of the i−1 previously selected items, A is selected based on the cumulative predicted utility for A and an expectation on the utility predicted for the item selected subsequently to A given the context that includes A. Such expectation can assume that a total of N items are to be selected and can compute the sum of utilities over the top ranked N−i items from the remaining items from the list of selected items.

### Example Devices and Systems

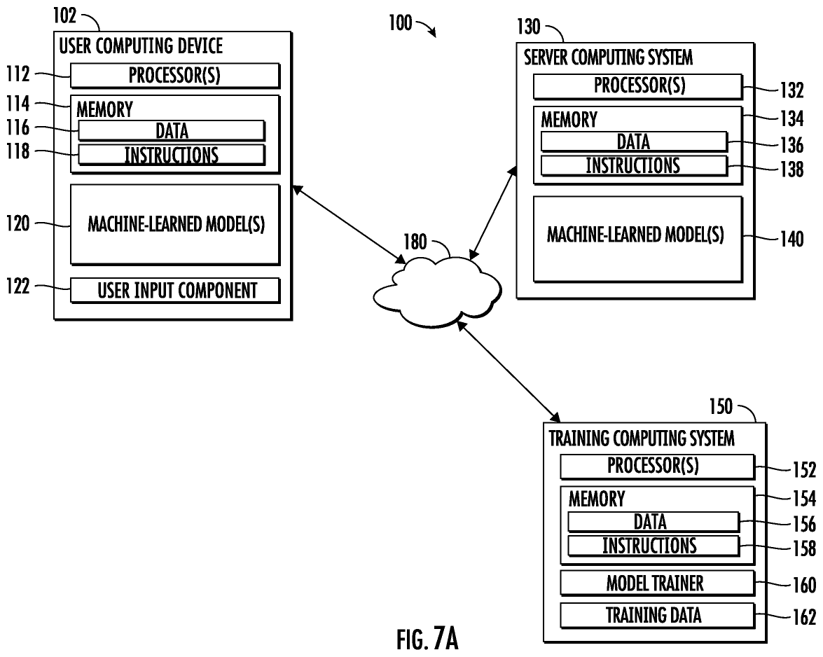

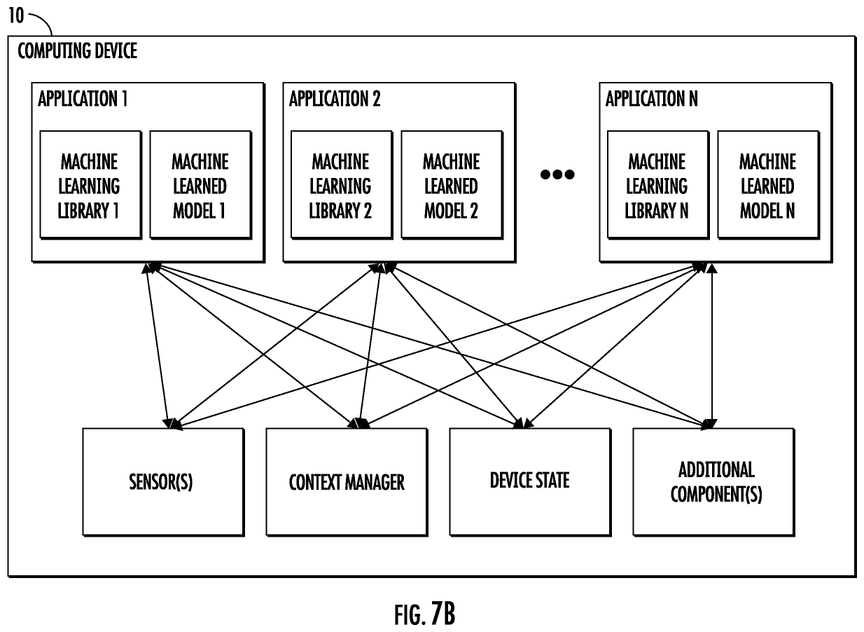

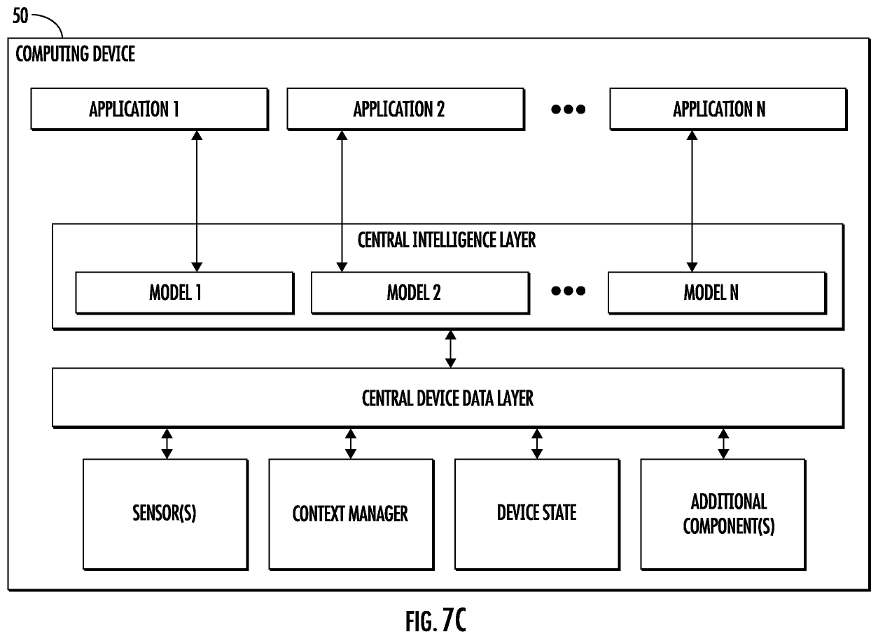

FIG. 7A depicts a block diagram of an example computing system 100 that according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine learning models 120. For example, the machine learning models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine learning models 120 are discussed with reference to FIGS. 1-6.

In some implementations, the one or more machine learning models 120 can be received from the server computing system 130 over network 180, stored in the user computing device memory 114, and then used or otherwise implemented by the one or more processors 112. In some implementations, the user computing device 102 can implement multiple parallel instances of a single machine learning model 120 (e.g., to perform parallel item ranking across multiple instances of queries).

Additionally or alternatively, one or more machine learning models 140 can be included in or otherwise stored and implemented by the server computing system 130 that communicates with the user computing device 102 according to a client-server relationship. For example, the machine learning models 140 can be implemented by the server computing system 140 as a portion of a web service (e.g., a search service, a recommendation service, etc.). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine learning models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 1-6.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine learning models 120 and/or 140 based on a set of training data 162. The training data 162 can include, for example, a number of training examples, where each training example includes a plurality of items and a plurality of labels respectively for the plurality of items. For example, each training example can correspond to a real-world event where a user was provided with a number of items and it was noted which of the item(s) the user chose to engage with.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 7A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 7B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 7B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 7C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 7C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 7C, the central device data layer can communicate with a number of other components of the computing device, such as, for example, one or more sensors, a context manager, a device state component, and/or additional components. In some implementations, the central device data layer can communicate with each device component using an API (e.g., a private API).

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method to train a machine learning model to perform joint engagement prediction, the method performed by a computing system comprising one or more computing devices, the method comprising:
obtaining a training example comprising a plurality of items and a plurality of ground truth labels respectively associated with the plurality of items; and
for one or more of the plurality of items:
processing, with a marginal network portion of the machine learning model, feature data for the item to generate an intermediate representation for the item;
processing, with the machine learning model, the intermediate representation for the item to generate a marginal label prediction for the item;
processing, with a joint network portion of the machine learning model, the intermediate representation for the item and data descriptive of one or more previously or concurrently selected items of the plurality of items to generate a joint label prediction for the item; and
modifying one or more parameters of the machine learning model based on one or more loss functions that evaluate the marginal label prediction for the item, the joint label prediction for the item, and the ground truth label for the item.

2. The computer-implemented method of claim 1, wherein the data descriptive of one or more previously or concurrently selected items of the plurality of items comprises summary embeddings associated with the one or more previously or concurrently selected items of the plurality of items.

3. The computer-implemented method of claim 1, wherein the data descriptive of one or more previously or concurrently selected items of the plurality of items comprises logit scores associated with the one or more previously or concurrently selected items of the plurality of items.

4. The computer-implemented method of claim 1, wherein the data descriptive of one or more previously or concurrently selected items of the plurality of items comprises a single summary score associated with the one or more previously or concurrently selected items of the plurality of items.

5. The computer-implemented method of claim 1, wherein the data descriptive of one or more previously or concurrently selected items of the plurality of items comprises the ground truth labels for the one or more previously or concurrently selected items of the plurality of items.

6. The computer-implemented method of claim 1, wherein the one or more previously or concurrently selected items comprises all previously or concurrently selected items.

7. The computer-implemented method of claim 1, wherein the one or more previously or concurrently selected items comprises only a top-k number of previously or concurrently selected items.

8. The computer-implemented method of claim 1, wherein the one or more loss functions comprise a joint loss function that generates a loss value based on the joint label prediction for the item and the ground truth label for the item, and wherein modifying one or more parameters of the machine learning model comprises modifying one or more parameters of the marginal network portion of the machine learning model based on the joint loss function.

9. The computer-implemented method of claim 8, wherein modifying the one or more parameters of the marginal network portion of the machine learning model comprises backpropagating the joint loss function through a processing path that includes the intermediate representation for the item.

10. The computer-implemented method of claim 8, wherein:
the data descriptive of the one or more previously or concurrently selected items of the plurality of items comprises or is derived from outputs of one or more prior instantiations of the marginal network portion of the machine learning model; and
modifying the one or more parameters of the marginal network portion of the machine learning model comprises backpropagating the joint loss function through a processing path that includes the one or more prior instantiations of the marginal network.

11. The computer-implemented method of claim 1, wherein any training loss applied either on the marginal or the joint network is a ranking loss on a set of items processing intermediate and ground truth labels of the previously or concurrently selected items.

12. The computer-implemented method of claim 1, wherein the method is implemented on a relatively more complex teacher model to produce predictions used as ground truth for training a deployable relatively more simple student model.

13. The computer-implemented method of claim 1, wherein no marginal loss is applied on the marginal network portion, and inference of a deployable model is taken for a context-free prediction of an item in a first position.

14. The computer-implemented-method of claim 1, wherein the machine learning model consists of the marginal network portion, a context network portion, and a label network portion, wherein a loss is applied at training on each of the network portions, and wherein inference is performed using predictions of the marginal and context networks.

15. The computer-implemented method of claim 1, wherein dropout on a random fraction of training steps is applied on ground truth label information of the previous or concurrently selected items in training, and wherein inference is performed with dropout to determine predictions of a label of a selected item.

16. A computer-implemented method to perform joint engagement prediction with a machine-learned model, the method performed by a computing system comprising one or more computing devices, the method comprising:
for one or more of a plurality of items to be included in a list of items responsive to a query:
processing, with a joint network portion of the machine-learned model, an intermediate representation generated for the item and data descriptive of one or more previously or concurrently selected items of the plurality of items to generate a joint label prediction for the item; and
generating the list of items responsive to the query based at least in part on the joint label prediction generated for each of the one or more of the plurality of items.

17. The computer-implemented method of claim 16, further comprising using a marginal network prediction to select items and using the joint label prediction from the joint network portion to rank the items based on a utility score.

18. (canceled)

19. The computer-implemented method of claim 16, wherein the data descriptive of one or more previously or concurrently selected items of the plurality of items comprises summary embeddings associated with the one or more previously or concurrently selected items of the plurality of items or comprises logit scores associated with the one or more previously or concurrently selected items of the plurality of items.

20. (canceled)

21. The computer-implemented method of claim 16, wherein the data descriptive of one or more previously or concurrently selected items of the plurality of items comprises a single summary score associated with the one or more previously or concurrently selected items of the plurality of items.

22. (canceled)

23. (canceled)

24. (canceled)

25. The computer-implemented method of claim 16, wherein the intermediate representation generated for the item was used to select the item for inclusion in the list or was generated by a marginal network portion of the machine-learned model.

26. (canceled)

27. (canceled)
